(19) United States
(12) Patent Application Publication
(10) Pub. No.: US 2016/0117787 A1
(43) Pub. Date: Apr. 28, 2016

(54) System and method for testator-mediated inheritor-driven inheritance planning

(71) Applicant: iBequeath, LLC, Austin, TX (US)

(72) Inventor: Thomas L. Zschiesche, Austin, TX (US)

(21) Appl. No.: 14/524,124

(22) Filed: Oct. 27, 2014

(51) Int. Cl. G06Q 50/18; G06Q 10/10

(52) U.S. Cl. CPC G06Q 50/186; G06Q 10/10

(57) ABSTRACT

A method for testator-mediated inheritor-driven inheritance planning includes receiving, by a computing device, from a testator, a description of at least one possession of the testator. The method includes providing, by the computing device, the description to a set of potential inheritors. The method includes receiving, by the computing device, a plurality of requests to inherit the at least one possession, each request in the plurality of requests received from one of a plurality of potential inheritors in the set of potential inheritors. The method includes providing, by the computing device, the plurality of requests to the testator. The method includes receiving, by the computing device, an instruction from the testator selecting an inheritor of the at least one possession from the plurality of potential inheritors.

### TECHNICAL FIELD

Embodiments disclosed herein relate generally to systems for inheritance planning, and specifically to the equitable and optimally satisfactory distribution of inherited property.

### BACKGROUND ART

Deciding how wealth and personal effects should be inherited is a crucial part of end-of-life planning, but it is fraught with practical and emotional difficulties. Family members often have expectations regarding their inheritance that they are not even aware of until the moment the will is read, and the disappointment over what appear to be unjust or impractical allocations of the decedent's wealth can foul the grieving process. Sometimes, disputes and resentment over inheritance can tear families apart. In addition to the innate desire for equitable treatment, heirs will often have various personal hopes regarding the decedent's property. Some may have a sentimental attachment to a particular property item. Others may have a particular practical need, such as the need to live in a dwelling that is part of the decedent's estate. For a conscientious testator, addressing all of these needs can be a very complicated process. The very acknowledgement of one's own mortality is reason enough to procrastinate when faced with the smallest practical hurdle.

There is thus a need for a convenient and effective way to plan the distribution of a testator's property among family and friends.

### SUMMARY OF THE EMBODIMENTS

A method is disclosed for testator-mediated inheritor-driven inheritance planning The method includes receiving, by a computing device, from a testator, a description of at least one possession of the testator. The method includes providing, by the computing device, the description to a set of potential inheritors. The method includes receiving, by the computing device, a plurality of requests to inherit the at least one possession, each request of the plurality of requests received from one of a plurality of potential inheritors in the set of potential inheritors. The method includes providing, by the computing device, the plurality of requests to the testator. The method includes receiving, by the computing device, an instruction from the testator selecting an inheritor of the at least one possession from the plurality of potential inheritors.

In a related embodiment, receiving the description also includes capturing a digital image of the possession. In another related embodiment, receiving the description also involves capturing a video of the possession. In an additional embodiment, receiving the description further includes recording a location of the possession. In another embodiment, providing the description further involves receiving, from the testator, a description of the set of potential inheritors. Another embodiment still involves receiving, from the testator, an instruction to remove at least one potential inheritor from the list. Yet another embodiment also includes receiving, from the testator, an instruction to add at least one potential inheritor to the list.

In a further embodiment, receiving the plurality of requests additionally involves receiving an indication of value of the possession to at least one potential inheritor of the plurality of potential inheritors. In a further embodiment still, receiving the indication of value also includes receiving a number representing the degree of value to the at least one potential inheritor. In another embodiment, receiving the indication of value further includes receiving, from the at least one potential inheritor, a ranking of the possession relative to a plurality of other items. In still another embodiment, receiving the indication of value further involves receiving, from the at least one inheritor, a qualitative description of the value of the possession to the at least one inheritor.

In another related embodiment, receiving the instruction from the testator selecting the inheritor also includes receiving an instruction from the testator selecting an alternate recipient to receive the at least one possession if the inheritor cannot receive the at least one possession. In a still further embodiment, receiving the instruction from the testator selecting the inheritor additionally involves determining that the instruction violates a property distribution requirement, alerting the testator regarding the violation and receiving a second instruction rectifying the violation. In another embodiment, receiving the second instruction further includes receiving an instruction modifying the inheritor of the at least one possession. In still another embodiment, receiving the second instruction further involves receiving an instruction modifying the inheritor of at least one additional possession. In an additional embodiment, receiving the second instruction additionally includes receiving an instruction modifying the property distribution requirement.

Another embodiment also includes providing, to at least one potential inheritor of the set of potential inheritors, the identity of the selected inheritor. Another embodiment also involves receiving, by the computing device, an instruction from the testator selecting an inheritor of at least one additional possession from the set of potential inheritors. Yet another embodiment also involves receiving, by the computing device, an instruction to distribute the at least one possession and publishing, by the computing device, to the set of potential inheritors, notification that distribution will take place.

Also disclosed is a system for testator-mediated inheritor-driven inheritance planning The system includes a computing device. The system includes a data input component, executing on the computing device, and configured to receive from a testator, a description of at least one possession of the testator, to receive a plurality of requests to inherit the at least one possession, each request of the plurality of requests received from one of a plurality of potential inheritors, and to receive an instruction from the testator selecting an inheritor of the at least one possession from the plurality of potential inheritors. The system includes a user interface component, executing on the computing device, and configured to provide the description to a set of potential inheritors and to provide, by the computing device, the plurality of requests to the testator.

Other aspects, embodiments and features of the system and method will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the system and method shown where illustration is not necessary to allow those of ordinary skill in the art to understand the system and method.

### BRIEF DESCRIPTION OF THE DRAWINGS

The preceding summary, as well as the following detailed description of the disclosed system and method, will be better understood when read in conjunction with the attached drawings. For the purpose of illustrating the system and method, presently preferred embodiments are shown in the drawings. It should be understood, however, that neither the system nor the method is limited to the precise arrangements and instrumentalities shown.

FIG. 1A is a schematic diagram depicting an example of an computing device as described herein;

FIG. 1B is a schematic diagram of a network-based platform, as disclosed herein;

FIG. 2 is a block diagram depicting one embodiment of the disclosed system; and

FIG. 3 is a flow chart illustrating one embodiment of the claimed method.

### DETAILED DESCRIPTION OF SPECIFIC EMBODIMENTS

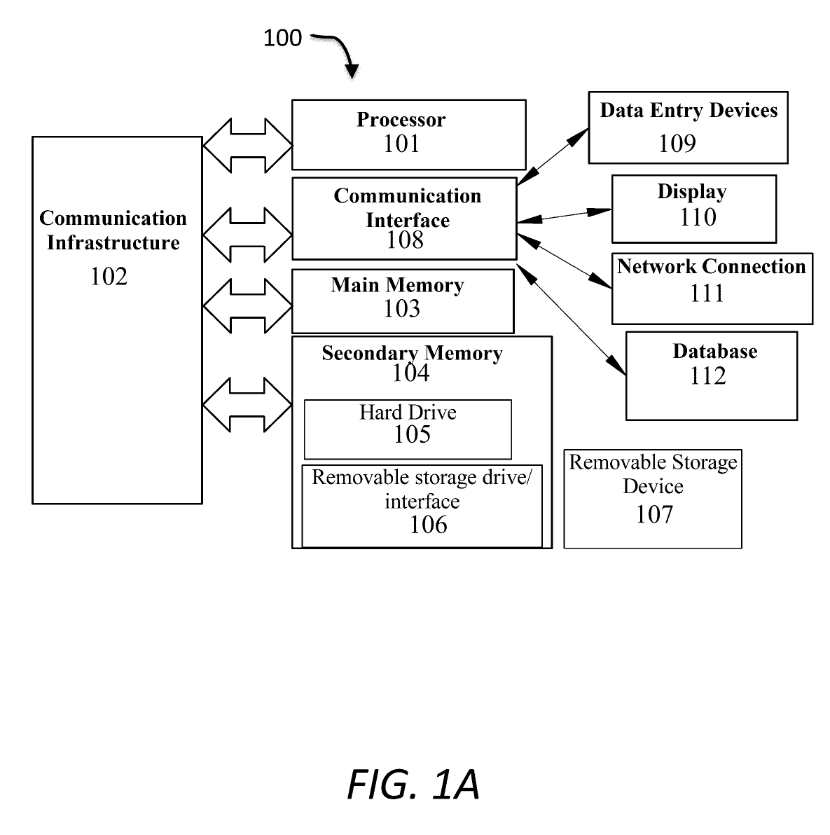

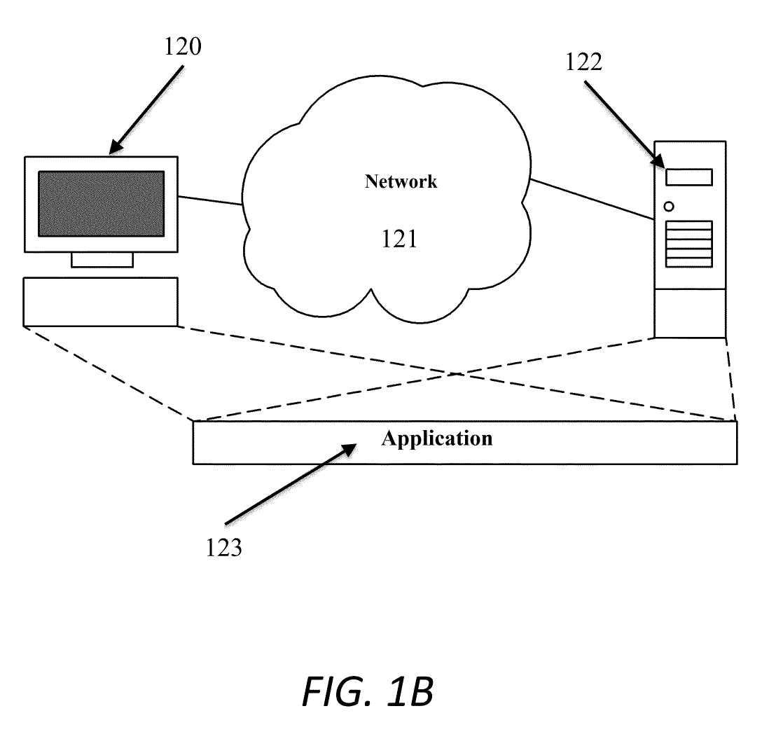

Some embodiments of the disclosed system and methods will be better understood by reference to the following comments concerning computing devices. A “computing device” may be defined as including personal computers, laptops, tablets, smart phones, and any other computing device capable of supporting an application as described herein. The system and method disclosed herein will be better understood in light of the following observations concerning the computing devices that support the disclosed application, and concerning the nature of web applications in general. An exemplary computing device is illustrated by FIG. 1A. The processor 101 may be a special purpose or a general-purpose processor device. As will be appreciated by persons skilled in the relevant art, the processor device 101 may also be a single processor in a multi-core/multiprocessor system, such system operating alone, or in a cluster of computing devices operating in a cluster or server farm. The processor 101 is connected to a communication infrastructure 102, for example, a bus, message queue, network, or multi-core message-passing scheme.

The computing device also includes a main memory 103, such as random access memory (RAM), and may also include a secondary memory 104. Secondary memory 104 may include, for example, a hard disk drive 105, a removable storage drive or interface 106, connected to a removable storage unit 107, or other similar means. As will be appreciated by persons skilled in the relevant art, a removable storage unit 107 includes a computer usable storage medium having stored therein computer software and/or data. Examples of additional means creating secondary memory 104 may include a program cartridge and cartridge interface (such as that found in video game devices), a removable memory chip (such as an EPROM, or PROM) and associated socket, and other removable storage units 107 and interfaces 106 which allow software and data to be transferred from the removable storage unit 107 to the computer system. In some embodiments, to “maintain” data in the memory of a computing device means to store that data in that memory in a form convenient for retrieval as required by the algorithm at issue, and to retrieve, update, or delete the data as needed.

The computing device may also include a communications interface 108. The communications interface 108 allows software and data to be transferred between the computing device and external devices. The communications interface 108 may include a modem, a network interface (such as an Ethernet card), a communications port, a PCMCIA slot and card, or other means to couple the computing device to external devices. Software and data transferred via the communications interface 108 may be in the form of signals, which may be electronic, electromagnetic, optical, or other signals capable of being received by the communications interface 108. These signals may be provided to the communications interface 108 via wire or cable, fiber optics, a phone line, a cellular phone link, and radio frequency link or other communications channels. Other devices may be coupled to the computing device 100 via the communications interface 108. In some embodiments, a device or component is “coupled” to a computing device 100 if it is so related to that device that the product or means and the device may be operated together as one machine. In particular, a piece of electronic equipment is coupled to a computing device if it is incorporated in the computing device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the computing device by shared membership in some network consisting of wireless and wired connections between multiple machines (e.g. a printer in an office that prints documents to computers belonging to that office, no matter where they are, so long as they and the printer can connect to the internet). A computing device 100 may be coupled to a second computing device (not shown); for instance, a server may be coupled to a client device, as described below in greater detail.

The communications interface in the system embodiments discussed herein facilitates the coupling of the computing device with data entry devices 109, the device's display 110, and network connections, whether wired or wireless 111. In some embodiments, “data entry devices” 109 are any equipment coupled to a computing device that may be used to enter data into that device. This definition includes, without limitation, keyboards, computer mice, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure. A computing device's “manual data entry devices” is the set of all data entry devices coupled to the computing device that permit the user to enter data into the computing device using manual manipulation. Manual entry devices include without limitation keyboards, keypads, touchscreens, track-pads, computer mice, buttons, and other similar components. A computing device may also possess a navigation facility. The computing device's “navigation facility” may be any facility coupled to the computing device that enables the device accurately to calculate the device's location on the surface of the Earth. Navigation facilities can include a receiver configured to communicate with the Global Positioning System or with similar satellite networks, as well as any other system that mobile phones or other devices use to ascertain their location, for example by communicating with cell towers. A code scanner coupled to a computing device is a device that can extract information from a “code” attached to an object. In one embodiment, a code contains data concerning the object to which it is attached that may be extracted automatically by a scanner; for instance, a code may be a bar code whose data may be extracted using a laser scanner. A code may include a quick-read (QR) code whose data may be extracted by a digital scanner or camera. A code may include a radio frequency identification (RFID) tag.

In some embodiments, a computing device's “display” 109 is a device coupled to the computing device, by means of which the computing device can display images. Display include without limitation monitors, screens, television devices, and projectors.

Computer programs (also called computer control logic) are stored in main memory 103 and/or secondary memory 104. Computer programs may also be received via the communications interface 108. Such computer programs, when executed, enable the processor device 101 to implement the system embodiments discussed below. Accordingly, such computer programs represent controllers of the system. Where embodiments are implemented using software, the software may be stored in a computer program product and loaded into the computing device using a removable storage drive or interface 106, a hard disk drive 105, or a communications interface 108.

The computing device may also store data in database 112 accessible to the device. A database 112 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 112, and can be accessed by more complex queries, using languages such as Structured Query Language, which retrieve data based on limiting values passed as parameters and relationships between the data being retrieved. More specialized queries, such as image matching queries, may also be used to search some databases. A database can be created in any digital memory.

Persons skilled in the relevant art will also be aware that while any computing device must necessarily include facilities to perform the functions of a processor 101, a communication infrastructure 102, at least a main memory 103, and usually a communications interface 108, not all devices will necessarily house these facilities separately. For instance, in some forms of computing devices as defined above, processing 101 and memory 103 could be distributed through the same hardware device, as in a neural net, and thus the communications infrastructure 102 could be a property of the configuration of that particular hardware device. Many devices do practice a physical division of tasks as set forth above, however, and practitioners skilled in the art will understand the conceptual separation of tasks as applicable even where physical components are merged.

The computing device 100 may employ one or more security measures to protect the computing device 100 or its data. For instance, the computing device 100 may protect data using a cryptographic system. In one embodiment, a cryptographic system is a system that converts data from a first form, known as “plaintext,” which is intelligible when viewed in its intended format, into a second form, known as “cyphertext,” which is not intelligible when viewed in the same way. The cyphertext is may be unintelligible in any format unless first converted back to plaintext. In one embodiment, the process of converting plaintext into cyphertext is known as “encryption.” The encryption process may involve the use of a datum, known as an “encryption key,” to alter the plaintext. The cryptographic system may also convert cyphertext back into plaintext, which is a process known as “decryption.” The decryption process may involve the use of a datum, known as a “decryption key,” to return the cyphertext to its original plaintext form. In embodiments of cryptographic systems that are “symmetric,” the decryption key is essentially the same as the encryption key: possession of either key makes it possible to deduce the other key quickly without further secret knowledge. The encryption and decryption keys in symmetric cryptographic systems may be kept secret, and shared only with persons or entities that the user of the cryptographic system wishes to be able to decrypt the cyphertext. One example of a symmetric cryptographic system is the Advanced Encryption Standard (“AES”), which arranges plaintext into matrices and then modifies the matrices through repeated permutations and arithmetic operations with an encryption key. In embodiments of cryptographic systems that are “asymmetric,” either the encryption or decryption key cannot be readily deduced without additional secret knowledge, even given the possession of the corresponding decryption or encryption key, respectively; a common example is a “public key cryptographic system,” in which possession of the encryption key does not make it practically feasible to deduce the decryption key, so that the encryption key may safely be made available to the public. An example of a public key cryptographic system is RSA, in which the encryption key involves the use of numbers that are products of very large prime numbers, but the decryption key involves the use of those very large prime numbers, such that deducing the decryption key from the encryption key requires the practically infeasible task of computing the prime factors of a number which is the product of two very large prime numbers.

The systems may be deployed in a number of ways, including on a stand-alone computing device, a set of computing devices working together in a network, or a web application. Persons of ordinary skill in the art will recognize a web application as a particular kind of computer program system designed to function across a network, such as the Internet. A schematic illustration of a web application platform is provided in FIG. 1A. Web application platforms typically include at least one client device 120, which is an computing device as described above. The client device 120 connects via some form of network connection to a network 121, such as the Internet. The network 121 may be any arrangement that links together computing devices 120, 122, and includes without limitation local and international wired networks including telephone, cable, and fiber-optic networks, wireless networks that exchange information using signals of electromagnetic radiation, including cellular communication and data networks, and any combination of those wired and wireless networks. Also connected to the network 121 is at least one server 122, which is also an computing device as described above, or a set of computing devices that communicate with each other and work in concert by local or network connections. Of course, practitioners of ordinary skill in the relevant art will recognize that a web application can, and typically does, run on several servers 122 and a vast and continuously changing population of client devices 120. Computer programs on both the client device 120 and the server 122 configure both devices to perform the functions required of the web application 123. Web applications 123 can be designed so that the bulk of their processing tasks are accomplished by the server 122, as configured to perform those tasks by its web application program, or alternatively by the client device 120. Some web applications 123 are designed so that the client device 120 solely displays content that is sent to it by the server 122, and the server 122 performs all of the processing, business logic, and data storage tasks. Such “thin client” web applications are sometimes referred to as “cloud” applications, because essentially all computing tasks are performed by a set of servers 122 and data centers visible to the client only as a single opaque entity, often represented on diagrams as a cloud.

Many computing devices, as defined herein, come equipped with a specialized program, known as a web browser, which enables them to act as a client device 120 at least for the purposes of receiving and displaying data output by the server 122 without any additional programming. Web browsers can also act as a platform to run so much of a web application as is being performed by the client device 120, and it is a common practice to write the portion of a web application calculated to run on the client device 120 to be operated entirely by a web browser. Such browser-executed programs are referred to herein as “client-side programs,” and frequently are loaded onto the browser from the server 122 at the same time as the other content the server 122 sends to the browser. However, it is also possible to write programs that do not run on web browsers but still cause an computing device to operate as a web application client 120. Thus, as a general matter, web applications 123 require some computer program configuration of both the client device (or devices) 120 and the server 122. The computer program that comprises the web application component on either computing device's system FIG. 1A configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Furthermore, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

The one or more client devices 120 and the one or more servers 122 may communicate using any protocol according to which data may be transmitted from the client 120 to the server 122 and vice versa. As a non-limiting example, the client 120 and server 122 may exchange data using the Internet protocol suite, which includes the transfer control protocol (TCP) and the Internet Protocol (IP), and is sometimes referred to as TCP/IP. In some embodiments, the client and server 122 encrypt data prior to exchanging the data, using a cryptographic system as described above. In one embodiment, the client 120 and server 122 exchange the data using public key cryptography; for instance, the client and the server 122 may each generate a public and private key, exchange public keys, and encrypt the data using each others' public keys while decrypting it using each others' private keys.

In some embodiments, the client 120 authenticates the server 122 or vice-versa using digital certificates. In one embodiment, a digital certificate is a file that conveys information and links the conveyed information to a “certificate authority” that is the issuer of a public key in a public key cryptographic system. The certificate in some embodiments contains data conveying the certificate authority's authorization for the recipient to perform a task. The authorization may be the authorization to access a given datum. The authorization may be the authorization to access a given process. In some embodiments, the certificate may identify the certificate authority.

The linking may be performed by the formation of a digital signature. In one embodiment, a digital signature is an encrypted a mathematical representation of a file using the private key of a public key cryptographic system. The signature may be verified by decrypting the encrypted mathematical representation using the corresponding public key and comparing the decrypted representation to a purported match that was not encrypted; if the signature protocol is well-designed and implemented correctly, this means the ability to create the digital signature is equivalent to possession of the private decryption key. Likewise, if the mathematical representation of the file is well-designed and implemented correctly, any alteration of the file will result in a mismatch with the digital signature; the mathematical representation may be produced using an alteration-sensitive, reliably reproducible algorithm, such as a hashing algorithm. A mathematical representation to which the signature may be compared may be included with the signature, for verification purposes; in other embodiments, the algorithm used to produce the mathematical representation is publically available, permitting the easy reproduction of the mathematical representation corresponding to any file. In some embodiments, a third party known as a certificate authority is available to verify that the possessor of the private key is a particular entity; thus, if the certificate authority may be trusted, and the private key has not been stolen, the ability of a entity to produce a digital signature confirms the identity of the entity, and links the file to the entity in a verifiable way. In other embodiments, the digital signature is verified by comparing the digital signature to one known to have been created by the entity that purportedly signed the digital signature; for instance, if the public key that decrypts the known signature also decrypts the digital signature, the digital signature may be considered verified. The digital signature may also be used to verify that the file has not been altered since the formation of the digital signature.

The server 122 and client 120 may communicate using a security combining public key encryption, private key encryption, and digital certificates. For instance, the client 120 may authenticate the server 122 using a digital certificate provided by the server 122. The server 122 may authenticate the client 120 using a digital certificate provided by the client 120. After successful authentication, the device that received the digital certificate possesses a public key that corresponds to the private key of the device providing the digital certificate; the device that performed the authentication may then use the public key to convey a secret to the device that issued the certificate. The secret may be used as the basis to set up private key cryptographic communication between the client 120 and the server 122; for instance, the secret may be a private key for a private key cryptographic system. The secret may be a datum from which the private key may be derived. The client 120 and server 122 may then uses that private key cryptographic system to exchange information until the in which they are communicating ends. In some embodiments, this handshake and secure communication protocol is implemented using the secure sockets layer (SSL) protocol. In other embodiments, the protocol is implemented using the transport layer security (TLS) protocol. The server 122 and client 120 may communicate using hyper-text transfer protocol secure (HTTPS).

Embodiments of the disclosed methods and system allow a testator to plan the inheritance of his or her property in a fair, dignified, and harmonious way. By taking requests from potential inheritors and allowing the testator to mediate conflicting requests, the system helps to ensure that inheritors are optimally satisfied with the distribution of property, while guaranteeing that the wishes of the testator are followed. The ability to record audio, video, and textual messages from the inheritors to the testator, and from the testator to the inheritors, allows users to add the degree of personalization with which they feel most comfortable to the process.

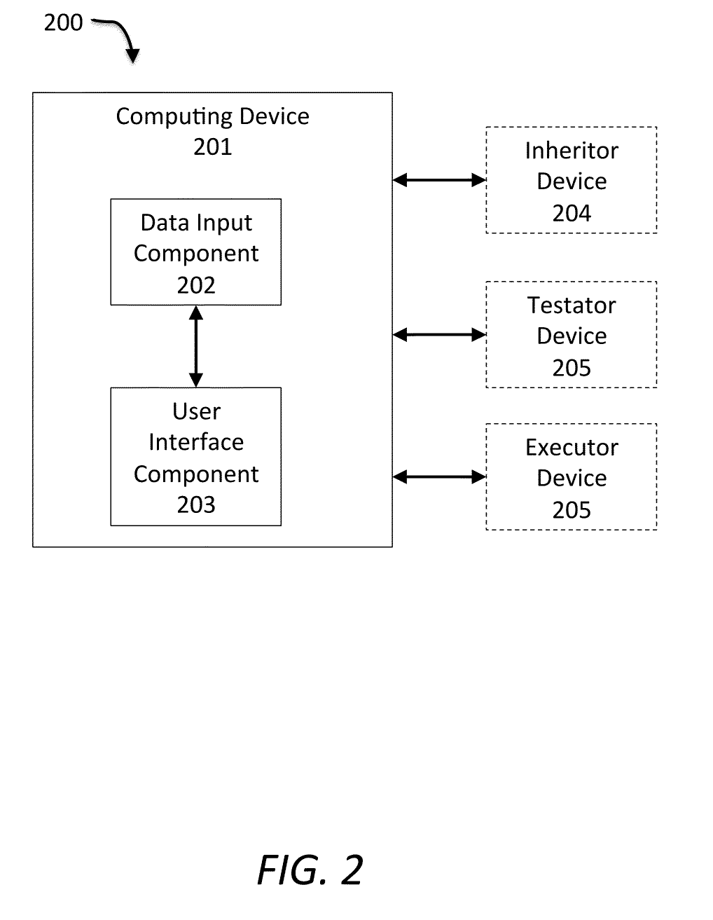

FIG. 2 illustrates some embodiments of the disclosed system 200. The system 200 includes a computing device 201. Executing on the computing device 201 is a set of algorithmic steps that may be conceptually described as creating a data input component 202 and a user interface component 203. The organization of tasks into those two components solely reflects a categorization of the tasks to be performed, and does not dictate the architecture of particular implementations of the system 200. For instance, in some embodiments of the system 200, the steps performed are executed by various objects in an object-oriented language, but the objects divide the tasks in a different manner than the above division. In other embodiments, the algorithmic steps exist as a set of instructions in a non-object oriented language, with no explicit separation of responsibility for steps into distinct components at all. Persons skilled in the art will recognize the existence of a broad variety of programming approaches that could cause the computing device 201 to perform the algorithmic steps.

Embodiments of the disclosed system and method concern the distribution of property upon the death of a person to other people. In some embodiments, the person whose property will be distributed is known as a testator. The people who receive the property upon distribution may be referred to as inheritors, or heirs, of the property. In some embodiments, the inheritors are members of the testator's family. In other embodiments, the inheritors are friends of the testator. The inheritors may be creditors of the testator. In some embodiments, the property of the testator is automatically distributed among people having legally recognized relationships with the testator, according to intestacy laws; for instance, the spouse of the testator may ordinarily inherit a certain subset of the testator's property unless the testator prepares a legal document stating otherwise. These laws may vary between jurisdictions, and an embodiment of the disclosed system may contain adaptations to jurisdiction-specific rules based upon the location of the testator, the inheritors, or both.

In some embodiments, the distribution of the property is subject to one or more property distribution requirements. In an embodiment, a property distribution requirement is a parameter for property distribution that the system 200 follows. The property distribution requirement may require that a particular potential inheritor must receive a certain fraction of value of the overall property of the testator. The property distribution requirement may require that a potential inheritor belonging to a particular class of potential inheritors must receive a certain fraction of value of the overall property of the owner; for instance, the property distribution requirement may require that all children of the inheritor equally divide a certain portion of the property of the testator. The property distribution requirement may require that a particular potential inheritor must receive a certain item of property of the testator; for example, the property distribution requirement may require that the spouse of the testator receive the testator's house. The property distribution requirement may require that a particular potential inheritor must receive all possessions belonging to a certain class of property of the testator; for example, the property distribution requirement may require that the spouse of the testator receive the furnishing and appliances included in the testator's house. The property distribution requirement may require that a particular class of potential inheritors receive all items belonging to a particular class of property; for instance, the property distribution requirement may require that all books belonging to the testator be divided among the testator's children. The property distribution requirement may place one or more items of property outside the property that may be distributed; for instance, if the testator owns a house or bank account jointly with another person, such as the testator's spouse, that person may legally become the sole owner of the jointly owned property upon the testator's death, making that property unavailable for distribution to inheritors.

The property distribution requirement may be created by the testator; for instance, the testator may instruct the system 200 to make sure that the testator's spouse and children each receive an equal share of the value of the testator's property. The property distribution requirement may be created by contract; for instance, when the testator becomes the joint owner of an item of property with another person, the contract by means of which the testator and the other person became joint owners may impose a property distribution requirement enforcing the joint ownership. The property distribution requirement may be created by law. As an example, the jurisdiction in which the testator is domiciled may make it illegal to dispossess a spouse of a certain share of the testator's property.

Referring to FIG. 2 in more detail, the system 200 includes a computing device 201. In some embodiments, the computing device 201 is a computing device 100 as disclosed above in reference to FIG. 1A. In other embodiments, the computing device 201 is a set of computing devices 100, as discussed above in reference to FIG. 1A, working in concert; for example, the computing device 201 may be a set of computing devices in a parallel computing arrangement. The computing device 201 may be a set of computing devices 100 coordinating their efforts over a private network, such as a local network or a virtual private network (VPN). The computing device 201 may be a set of computing devices 100 coordinating the efforts over a public network, such as the Internet. The division of tasks between computing devices 100 in such a set of computing devices working in concert may be a parallel division of tasks or a temporal division of tasks; as an example, several computing devices 100 may be working in parallel on components of the same tasks at the same time, where as in other situations one computing device 100 may perform one task then send the results to a second computing device 100 to perform a second task. In one embodiment, the computing device 201 is a server 122 as disclosed above in reference to FIG. 1B. The computing device 201 may communicate with one or more additional servers 122. The computing device 201 and the one or more additional servers 122 may coordinate their processing to emulate the activity of a single server 122 as described above in reference to FIG. 1B. The computing device 201 and the one or more additional servers 122 may divide tasks up heterogeneously between devices; for instance, the computing device 201 may delegate the tasks of the data input component 202 to an additional server 122. In some embodiments, the computing device 201 functions as a client device 120 as disclosed above in reference to FIG. 1B.

The data input component 202 executes on the computing device 201. The data input component 202 in some embodiments is a computer program as described above in reference to FIGS. 1A and 1B. In some embodiments, the data input component 202 is configured to receive, from a testator, a description of at least one possession of the testator, to receive a plurality of requests to inherit the at least one possession, each request of the plurality of requests received from one of a plurality of potential inheritors, and to receive an instruction from the testator selecting an inheritor of the at least one possession from the plurality of potential inheritors.

The user interface component 203 executes on the computing device 201. In some embodiments, the user interface component 203 is a computer program as described above in reference to FIGS. 1A and 1B. In some embodiments, the user interface component 203 is configured to provide the description to a set of potential inheritors and to provide, by the computing device, the plurality of requests to the testator.

Some embodiments of the system 200 also include on or more inheritor devices 204 that communicate with the computing device 201. The inheritor device 204 may be a computing device 100 as described above in reference to FIGS. 1A-1B. The inheritor device 204 may be a client device 120 as described above in reference to FIGS. 1A-1B; for instance the inheritor device 204 may be a personal computer, a laptop, or a mobile device. In some embodiments one or more potential inheritors communicates with the computing device 201 as described below by means of an inheritor device 204. Some embodiments of the system 200 also include a testator device 205 that communicates with the computing device 201. The testator device 205 may be a computing device 100 as described above in reference to FIGS. 1A-1B. The testator device 205 may be a client device 120 as described above in reference to FIGS. 1A-1B; for instance the testator device 205 may be a personal computer, a laptop, or a mobile device. In some embodiments the testator communicates with the computing device 201 as described below by means of the testator device 205. Some embodiments of the system 200 also include an executor device 206 that communicates with the computing device 201. The executor device 206 may be a computing device 100 as described above in reference to FIGS. 1A-1B. The executor device 206 may be a client device 120 as described above in reference to FIGS. 1A-1B; for instance the executor device 206 may be a personal computer, a laptop, or a mobile device. In some embodiments an executor communicates with the computing device 201 as described below by means of the executor device 206. Any or all of the testator device 205, executor device 206, or inheritor devices 204 may communicate with the computing device 201 by means of a web application 123 as described above in reference to FIGS. 1A-1B; for example, inheritors, testator, and executor may interface with the computing device 201 as described in further detail below via a mobile application or by means of a web page loaded on a browser.

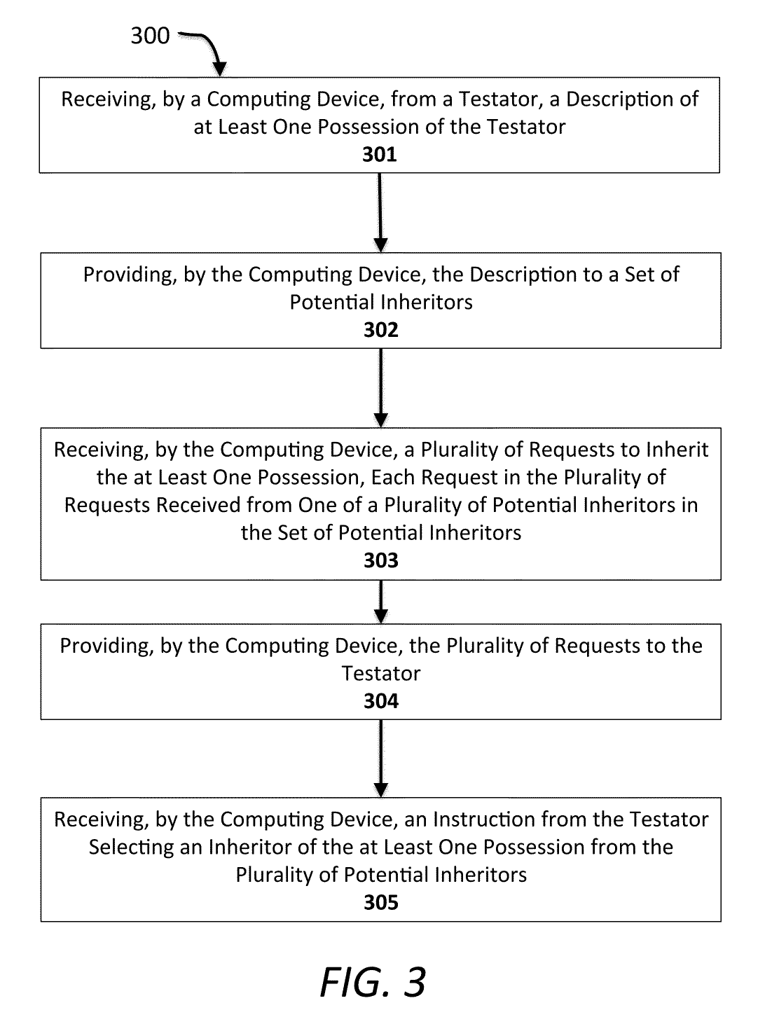

FIG. 3 illustrates some embodiments of a method 300 for testator-mediated inheritor-driven inheritance planning The method 300 includes receiving, by a computing device, from a testator, a description of at least one possession of the testator (301). The method 300 includes providing, by the computing device, the description to a set of potential inheritors (302). The method 300 includes receiving, by the computing device, a plurality of requests to inherit the at least one possession, each request of the plurality of requests received from one of a plurality of potential inheritors in the set of potential inheritors (303). The method 300 includes providing, by the computing device, the plurality of requests to the testator (304). The method 300 includes receiving, by the computing device, an instruction from the testator selecting an inheritor of the at least one possession from the plurality of potential inheritors (305).

Referring to FIG. 3 in greater detail, and by reference to FIG. 2, the data entry component 202 receives a description of at least one possession of the testator from the testator (301). Prior to entering the instruction, the testator may create a user account with the system 200. The user account may include a user identifier, such as a username, that uniquely identifies the testator. The user account may include a secret credential, such as a password, to authenticate the testator. The user account may include the name of the testator, including the personal name, the surname, and any intermediate names such as patronymic names, matronymic names, geographic names, religious names, “nicknames,” or “middle names.” In some embodiments, the user account includes contact information of the testator; the contact information may be a mailing or billing address. The contact information may be electronic contact information, which the computing device 201 can use to contact the testator via an electronic device such as a telephone or the testator device 205. The electronic contact information may include a phone number. The electronic information may include an electronic mail (email) address. The electronic information may include an identifier, such as a “screen name,” by means of which the testator may be identified and contacted according to any electronic communication protocol. In some embodiments, the user account includes a birthplace. In some accounts, the user account includes a birthdate. The user account may include one or more fields identifying the gender of the testator. The user account may include a data element describing how the testator learned about the system 200. In some embodiments, the system 200 grants only the testator access to describe the testator's property; in other embodiments, other users have access. The other users' access may be limited access, such as the ability to contribute additional information. The computing device 201 may provide the testator the ability to approve additional information, leaving it in the description, or to delete the additional information. The user interface component 203 may continue to require authentication the testator when the testator subsequently logs onto the system 200. Persons skilled in the art will be aware that a person may be a testator with regard to his or her property while simultaneously being an inheritor or executor, as set forth in further detail below, regarding the property of another person.

The testator may enter the instruction via a data entry device coupled to the computing device 201. The testator may enter the instruction via a testator device 205. The testator may enter the description via data entry devices coupled to the computing device 201; for instance, the testator may type the description. Another person may type the description on behalf of the testator. The testator, or a person acting on behalf of the testator, may scan a document describing the property; for example, the testator may scan a deed of a house or vehicle into the computing device 201. The data entry component 202 may use optical character recognition software to convert the scanned image of the file to textual data. Alternatively, the data entry component 202 may use the scanned image itself as all or part of the description. The data entry component 202 may receive the description from a computer-readable memory, such as a disc or a portable memory device. The data entry component 202 may receive the description from another computing device; for instance, the data entry component 202 may download a file containing the description from a third-party server (not shown) that has the file. In other embodiments, receiving the description includes capturing a digital image of the at least one possession, using a camera coupled to the computing device 201. In other embodiments, receiving the description includes capturing a video of the at least one possession, using a camera coupled to the computing device 201. The data entry component 202 may receive the description in part by recording a location of the at least one possession; for instance, the data entry component 202 may use a navigation facility coupled to a mobile to record the location of the mobile device when close to the at least one possession. The recorded location may be combined with other information concerning the at least one possession, such as a photograph; the photograph and location may be captured simultaneously. The testator may add a value for the at least one possession; the value may be a monetary value. The testator may estimate the monetary value. The testator may obtain the monetary value from an informed source. In some embodiments, the computing device 201 queries a remote device with valuation information using information provided by the testator; for instance, the testator may include the make, model, year of manufacture, mileage, and condition of an automobile, and the computing device 201 may transmit that information to a server containing automobile valuation information, and receive an estimated value in response. The testator may add a quantity rating the sentimental value of the at least one possession to the testator. The testator may add a quantity rating the sentimental value of the at least one possession to one or more potential inheritors.

In some embodiments, the data entry component 202 continues receiving additions to the description of the at least one possession. For instance, the testator may think of additional facts about the at least one possession, and add those additional facts to the description. The testator may think of additional anecdotes about the at least one possession and add the additional anecdotes to the description. In some embodiments, the data entry component 202 receives additions to the description of the at least one possession from other persons; for instance, when the user interface component 203 provides the description to the set of potential inheritors as described below, each potential inheritor may be able to enter additions to the description. As an example, one of the potential inheritors may have a video of a person using the at least one possession, and may add the recording to the description. One of the potential inheritors may have a recording of the testator telling a story about the at least one possession, and may add the recording to the description. The description may describe the at least one possession. The description may describe the history of the at least one possession. The description may include information in textual form. The description may include information in audio form. The description may include information in video form. The description may include a geographical digital map with indicators, such as “pin drops,” that indicate the locations where events pertaining to the possession occurred; the indications may include the times at which the events occurred. For instance, the location and time of purchases, repairs, special moments in the life of the testator or a potential inheritor, or the current location of the at least one possession may be included in the description; indications on a map may also be linked to any such event. The description may describe the current ownership, provenance, or possessor of the at least one possession; the current ownership, provenance, or possessor of the at least one possession may also be linked to an indicator on a map.

The user interface component 203 provides the description to the set of potential inheritors (302). The description may be provided to the set of potential inheritors via one or more inheritor devices 204. In some embodiments, the data entry component 202 receives a description of at least part of the set of potential inheritors from the testator. The testator may enter the names of the potential inheritors manually. In some embodiments, the user interface component 203 provides a guide, such as a “wizard” to aid the entry of potential inheritors; for instance, user interface component 203 may prompt the testator to enter the names and relationships to the testator of each of the testator's relatives. The user interface component 203 may prompt the testator to enter the names of friends. The testator may be able to amend the list of inheritors later; for instance, the data entry component 202 may receive an instruction from the testator to remove at least one potential inheritor from the list. The data entry component 202 may receive an instruction from the testator to add at least one potential inheritor to the list. The data entry component 202 may obtain the description of at least part of the set of potential inheritors from a list of contacts of the testator, such as a list of people who frequently correspond with the testator by electronic communication, or a list of email or telephone contacts. The data entry component 202 may load the contacts from a testator device 205. The data entry component 202 may load the contacts from a mobile device. The data entry component 202 may load the contacts from an account belonging to the testator, such as an email account. The user interface component 203 may ask the testator whether the testator wishes to obtain the potential inheritor descriptions from a contact list; the data entry component 202 may proceed only if the testator agrees to load the potential inheritor descriptions from the contact list. The user interface component 203 may give the testator the option to select or deselect persons on the contact list prior to their being imported as potential inheritors. The testator may be able to add information concerning the rights and privileges of each potential inheritor within the estate. As an example, the testator may or may not allow a potential inheritor to add notes or comments to the history of the item. The testator may or may not allow a potential inheritor to see which potential inheritor has been selected as the inheritor of the at least one possession; the potential inheritor may be permitted to see who the inheritor of the at least one possession is after an event has been recorded in the system, such as the death of the testator.. The testator may or may not allow a potential inheritor to amend or delete item comments other than their own. Furthermore, non-inheritors such as an independent administrator may be given rights and privileges in accordance with their legal status to implement rights and privileges delegated by the testator. The testator may be able to add information setting the rights and privileges of each potential inheritor in the system 200; for instance, one potential inheritor may have the right to modify descriptions of possessions, while another may only be able to view the descriptions.

In some embodiments, the user interface component 203 provides each potential inheritor of the set of potential inheritors with a message indicating that the description of the at least one possession is available for the potential inheritor to view. The message may be conveyed using any suitable means of electronic communication, including text messages, such as those sent via the simple messaging service (SMS) or email sent via simple mail transfer protocol (SMTP). The user interface component 203 may display all descriptions of possession to each potential inheritor. In other embodiments, the user interface component 203 only displays for a particular potential inheritor the possessions that potential inheritor is able to inherit; for instance, where the books belonging to the testator may only be inherited by one of the testator's children, only the children of the testator may be shown the descriptions of books belonging to the testator. Other factors determining how the at least one possession is distributed may include a time or event, such as arrival at a certain birthday or graduation from college.

In some embodiments, the computing device 201 creates a user account for each potential inheritor. The user account for each inheritor may include any of the elements of a user account for a testator, as described above in reference to step 301 of FIG. 3. The computing device 201 may create the user account for the potential inheritor when the set of potential inheritors is entered on the computing device 201. The user interface component 203 may send each potential inheritor credentials with which to log onto the automatically created user account initially. The user interface component 203 may prompt each potential inheritor to create a user account upon receiving the message indicating that the description is available for the potential inheritor to view. The user interface component 203 may prompt each potential inheritor to form a user account in a separate communication from the one in which the user interface component 203 informs the potential inheritor regarding the description. In other embodiments, the user interface component 203 prompts a potential inheritor to open a user account when the potential inheritor navigates to a website provided by the user interface component 203. The user interface component 203 may perform initial authentication of the potential inheritor; for instance, the user interface component 203 may request secret personal information from the potential inheritor, such as birthdate or social security number. The testator may provide further secret information to aid in authentication; in some embodiments, the user interface component 203 allows the potential inheritor to open an account only using data from the message sent to the potential inheritor, thus relying at least in part on contact information associated with the user by the testator for authentication. The user interface component 203 may continue to require authentication for potential inheritors who subsequently log on.

The data entry component 202 receives a plurality of requests to inherit the at least one possession; each request of the plurality of requests may be received from one of a plurality of potential inheritors (303). In some embodiments, the data entry component 202 receives an indication of value of the possession to at least one potential inheritor of the plurality of potential inheritors. The indication of value may be a number representing the degree of value to the at least one potential inheritor. The number may be a ranking on a numerical range, such as a range in which zero represents no interest, and ten represents maximal interest in the possession. The number may be a percentage of the potential inheritor's maximal interest in the possession. The number may represent an amount of money at which the inheritor values the possession. In other embodiments, the indication of value is a ranking of the possession relative to a plurality of other items. The plurality of other items may be other property making up the estate of the testator; thus, the ranking may represent how much the potential inheritor wants to receive the possession instead of another piece of the estate. In other embodiments, the indication of value to the potential inheritor includes a qualitative description of the value of the possession to the at least one inheritor. For instance, the potential inheritor may enter text explaining why the possession is important to him or her, or arguing why the potential inheritor is the most correct recipient. The potential inheritor may submit other items, such as a video or audio file. As another example, the potential inheritor or testator may submit a text note addressed to the potential, inheritor, testator, or other person; as noted above, rules implemented on the system 200 may dictate which users are able to view the video, audio, or text message or messages. For example, access may be limited only to the intended recipient of the video, audio, or text message or messages.

The user interface component 203 provides the plurality of requests to the testator (304). The testator may view the requests one at a time. The testator may compare two requests to each other; for instance, the user interface component 203 may present the two requests side-by-side on a split screen. The user interface component 203 may compare quantitative data concerning the two requests and present the comparison to the testator. As an example, if a first potential inheritor indicates his interest in the at least one possession is 5 out of 10, and the second potential inheritor indicates her interest in the at least one possession is 7 out of 10, the user interface component 203 may present the difference in the levels of interest to the testator. Likewise, where one potential inheritor ranks the at least one possession more highly relative to other possessions in the estate than another potential inheritor does, the user interface component 203 may present that difference to the testator. The user interface component 203 may display qualitative descriptions of value to the testator; for instance, the user interface component 203 may display text written by one potential inheritor, and play a video submitted by another potential inheritor.

The data entry component 202 receives an instruction from the testator selecting an inheritor of the at least one possession from the plurality of potential inheritors (305). The testator may select one inheritor. The testator may select two or more inheritors to inherit the same possession jointly; for instance, the possession may be a vacation home that several inheritors share, each of whom may use it by mutual arrangement. In some embodiments, the data entry component 202 receives an instruction from the testator selecting an alternate recipient to receive the at least one possession if the inheritor cannot receive the at least one possession. As an example, the intended inheritor may have died after the testator made the selection, but the testator may not have had a chance to update the selection to indicate a new inheritor; at the time of the initial selection, the testator may designate another potential inheritor as the alternate inheritor should the inheritor selected by the testator die prior to receiving the at least one possession. In some embodiments, the data entry component 202 receives a personal message from the testator for the inheritor. The testator may type the message. The testator may enter an audio recording or a video message. The message may explain the testator's selection to the inheritor. In some embodiments, the data entry component 202 receives a message from the testator for the potential inheritors that requested the at least one possession. In other embodiments, the data entry component 202 receives a message from the testator for the entire set of potential inheritors.

In some embodiments, the computing device determines that the instruction violates a property distribution requirement, alerts the testator regarding the violation, and receives a second instruction from the testator rectifying the violation. The computing device 201 may create the property distribution requirement automatically when the testator enters the set of potential inheritors on the computing device 201; for instance, when the testator identifies one of the potential inheritors as the testator's spouse, the computing device 201 may create a property distribution requirement that enforces a rule in the testator's jurisdiction that a testator must leave some fraction of his or her estate to the spouse. Where the testator describes a possession as jointly owned with another person, the computing device 201 may create a property distribution requirement placing the jointly owned property off limits for inheritance. In other embodiments, the testator directs the computing device 201 to create the property distribution requirement; for instance, the testator may wish to make sure that all of the testator's children receive a substantially equal share of the estate, and thus may direct the computing device 201 to create a property distribution requirement to that effect. Depending on the number of possessions to divide between inheritors, the testator may find it burdensome to keep track of the total value of the property intended for each potential inheritor. The creation of property distribution requirements may permit the computing device 201 to keep track of those rules while the testator deals with the potential inheritors' individual requests.

When the testator's selection violates a property distribution requirement, the user interface component 203 may alert the testator to the violation; for instance, the user interface component 203 may generate an error message describing the property distribution requirement that the selection violates. In some embodiments, the computing device 201 does not record the testator's selection if the selection violates a property distribution requirement. In other embodiments, the computing device 201 records the selection, but labels the selection so that the testator knows about the violation when viewing the selection via the user interface component 203.

The user interface 203 component may receive a second instruction rectifying the violation. In one embodiment, the instruction modifies the inheritor of the at least one possession. For instance, if the property distribution requirement requires that each inheritor of a certain group receive the same total value of property, and the initial selection grants one inheritor too great a total value, the testator may enter a second selection giving the at least one possession to another inheritor. In other embodiments, testator enters an instruction modifying the recipient of at least one additional possession. For example, if an inheritor will receive too great a total property value if given the at least one possession, the testator may enter an instruction giving another possession formerly intended for the inheritor to another potential inheritor. In another embodiment, the testator enters an instruction modifying the property distribution requirement; the instruction may create a single exception for the at least one possession, where the testator believes that violating the property distribution requirement is a better choice than modifying selections the testator has made. In some embodiments, the computing device 201 will not allow the testator to modify a property distribution requirement that is legally required, such as a statutory rule governing inheritance.

In some embodiments, the user interface component 203 provides the identity of the selected inheritor to at least one potential inheritor of the set of potential inheritors. In one embodiment, the selected inheritor is informed of the selection. In another embodiment, all potential inheritors who requested the possession are shown the identity of the selected inheritor. In other embodiments, all of the potential inheritors can see the selected inheritor for each possession. In some embodiments, the at least one potential inheritor can see the selection as soon as the selection has been made. In other embodiments, the at least one potential inheritor can see the selection only after an instruction to distribute the at least one possession has been entered, as described below. In some embodiments, the data entry component 202 receives an instruction from the testator selecting an inheritor of at least one additional possession from the set of potential inheritors. The additional possession may be a possession that none of the potential inheritors requested. The additional possession may be a possession the potential inheritors were not permitted to request.

In some embodiments, the data entry component 202 receives an instruction to distribute the at least one possession and the user interface component 203 publishes notification that distribution will take place to the set of potential inheritors. The instruction may be entered by an executor; for instance, the executor may learn that the testator has recently died, and enter the instruction as a result. In some embodiments, the executor is the only user of the system 200 able to enter the instruction. The executor may have a user account with the system 200; the user account of the executor may include any of the elements of a user account for a testator, as described above in reference to step 301 of FIG. 3. In some embodiments, personal messages recorded by the testator are also published to the inheritors only after the instruction to distribute the at least one possession is received.

In some embodiments, upon receiving an indication that the testator has died, the system 200 issues instructions for an executor or administrator to follow in distributing the property. For example, the system 200 may instruct the executor or administrator to distribute the at least one possession to the at least one inheritor that was selected to receive it. The system 200 may instruct the executor to distribute the at least one possession only after a certain time has passed, or a certain event has occurred, such as a birthday or college graduation as indicated above. In some embodiments, the system notifies the at least one inheritor that the at least one inheritor is scheduled to receive the at least one possession; the message may be conveyed by any form of electrical communication as described above. The at least one inheritor may be able to enter an instruction to the data entry component 202 regarding the inheritor's decision with regard to the receipt of the at least one possession; for instance, the inheritor may enter an instruction indicating that the inheritor accepts the distribution of the at least one possession to the inheritor. The inheritor may reject distribution of the at least one possession to the inheritor; the inheritor may allow the possession to devolve to the residue of the estate, or indicate an alternate inheritor. The alternate inheritor may be one of the potential inheritors as described above. The alternate inheritor may be another person. In some embodiments, the system 200 has one or more rules restricting who may be selected as an alternate inheritor; for instance, the testator may enter an instruction indicating that a particular person may not receive a particular possession or class of possessions, or may not receive any part of the estate.

If the inheritor scheduled to receive the at least one possession accepts receipt of the at least one possession, the system 200 may send the inheritor the history pertaining to the at least one possession, including any audio, video, map data or other descriptive data as described above in reference to FIG. 3. The system 200 may put the estate in “locked” mode upon a distribution triggering event, such as the death of the testator or the completion of one or more distributions of the at least one possession; when the estate is “locked,” the system 200 may not permit changes to the descriptions of possessions as describe above in reference to FIG. 3. Rules may govern who is permitted to view the “locked” estate, including the description of possessions as described above in reference to FIG. 3; for instance, the testator may indicate that only potential inheritors are able to view the descriptions. Likewise, the testator may indicate that only the inheritor or inheritors of a possession are able to see the description or descriptions of the possessions.

It will be understood that the system and method may be embodied in other specific forms without departing from the spirit or central characteristics thereof. The present examples and embodiments, therefore, are to be considered in all respects as illustrative and not restrictive, and the system method is not to be limited to the details given herein.

What is claimed is:

1. A method for testator-mediated inheritor-driven inheritance planning, the method comprising:
receiving, by a computing device, from a testator, a description of at least one possession of the testator;
providing, by the computing device, the description to a set of potential inheritors;
receiving, by the computing device, a plurality of requests to inherit the at least one possession, each request in the plurality of requests received from one of a plurality of potential inheritors in the set of potential inheritors;
providing, by the computing device, the plurality of requests to the testator; and
receiving, by the computing device, an instruction from the testator selecting an inheritor of the at least one possession from the plurality of potential inheritors.

2. A method according to claim 1, wherein receiving the description further comprises capturing a digital image of the possession.

3. A method according to claim 1, wherein receiving the description further comprises capturing a video of the possession.

4. A method according to claim 1, wherein receiving the description further comprises recording a location of the possession.

5. A method according to claim 1, wherein providing the description further comprises receiving, from the testator, a description of the set of potential inheritors.

6. A method according to claim 5 further comprising receiving, from the testator, an instruction to remove at least one potential inheritor from the list.

7. A method according to claim 5 further comprising receiving, from the testator, an instruction to add at least one potential inheritor to the list.

8. A method according to claim 1, wherein receiving the plurality of requests further comprises receiving an indication of value of the possession to at least one potential inheritor of the plurality of potential inheritors.

9. A method according to claim 8, wherein receiving the indication of value further comprises receiving a number representing the degree of value to the at least one potential inheritor.

10. A method according to 8, wherein receiving the indication of value further comprises receiving, from the at least one potential inheritor, a ranking of the possession relative to a plurality of other items.

11. A method according to 8, wherein receiving the indication of value further comprises receiving, from the at least one inheritor, a qualitative description of the value of the possession to the at least one inheritor.

12. A method according to claim 1, wherein receiving the instruction from the testator selecting the inheritor further comprises receiving an instruction from the testator selecting an alternate recipient to receive the at least one possession if the inheritor cannot receive the at least one possession.

13. A method according to claim 1, wherein receiving the instruction from the testator selecting the inheritor further comprises:
determining that the instruction violates a property distribution requirement;
alerting the testator regarding the violation; and
receiving a second instruction rectifying the violation.

14. A method according to claim 13, wherein receiving the second instruction further comprises receiving an instruction modifying the inheritor of the at least one possession.

15. A method according to claim 13, wherein receiving the second instruction further comprises receiving an instruction modifying the inheritor of at least one additional possession.

16. A method according to claim 13, wherein receiving the second instruction further comprises receiving an instruction modifying the property distribution requirement.

17. A method according to claim 1 further comprising providing, to at least one potential inheritor of the set of potential inheritors, the identity of the selected inheritor.

18. A method according to claim 1 further comprising receiving, by the computing device, an instruction from the testator selecting an inheritor of at least one additional possession from the set of potential inheritors.

19. A method according to claim 1 further comprising:
receiving, by the computing device, an instruction to distribute the at least one possession; and
publishing, by the computing device, to the set of potential inheritors, notification that distribution will take place.

20. A system for testator-mediated inheritor-driven inheritance planning, the system comprising:
a computing device;
a data input component, executing on the computing device, and configured to receive from a testator, a description of at least one possession of the testator, to receive a plurality of requests to inherit the at least one possession, each request from one of a plurality of potential inheritors, and to receive an instruction from the testator selecting an inheritor of the at least one possession from the plurality of potential inheritors; and
a user interface component, executing on the computing device, and configured to provide the description to a set of potential inheritors and to provide, by the computing device, the plurality of requests to the testator.
